(19) United States
(12) Patent Application Publication
(10) Pub. No.: US 2018/0203686 A1
(43) Pub. Date: Jul. 19, 2018

(54) METHOD FOR CONFIGURING A CRYPTOGRAPHIC PROGRAM TO BE EXECUTED BY A TERMINAL

(71) Applicant: Idemia Identity & Security France, Issy-Les-Moulineaux (FR)

(72) Inventors: Herve CHABANNE, Issy-Les-Moulineaux (FR); Julien BRINGER, Issy-Les-Moulineaux (FR)

(21) Appl. No.: 15/849,377

(22) Filed: Dec. 20, 2017

(30) Foreign Application Priority Data
Dec. 21, 2016 (FR) 1663001

(51) Int. Cl. G06F 8/65; H04L 9/32; G06F 21/53; H04L 9/08

(52) U.S. Cl. CPC G06F 8/65; H04L 9/3218; H04L 9/3231; H04L 9/088; G06F 21/53

(57) ABSTRACT

The present invention relates to a method for configuring a cryptographic program (P) intended to be executed by a terminal (1), the method including the following steps implemented by the terminal (1):
sending (102) to a secure element at least one execution command of an internal processing (F) by the secure element,
receiving (104) at least one response datum (y) produced by the internal processing (F) executed by the secure element, the response datum (y) being specific to the secure element,
updating the cryptographic program (P) according to the received response datum (y), such that output data produced by the cryptographic program (P) before and after the updating are different.

### FIELD OF THE INVENTION

The present invention relates to a method for configuring a cryptographic program intended to be executed by a terminal.

### PRIOR ART

A cryptographic program conventionally uses data mandated to remain secret, for example an underlying private key.

Some cryptographic programs are intended to be executed in authorized environments. For example, a cryptographic program functioning as digital rights management (DRM) is supposed to be executed only in the environment of an authorized user.

To figure out the secret data of a cryptographic program, an attack known as “cloning” or “code lifting” consists of copying the program to a non-secure environment under full control of an attacker. In such a non-secure environment, the program forms what is known as a “white box”: the attacker has access not only to the input and output data of the program, but also has access to the intermediate data computed by the program, and may perform reverse engineering to determine functions of the program.

To counter such an attack, it is possible to implement the cryptographic program in such a way that the attacker has to explore many possibilities to guess the secret data. So, even if the execution environment of the program is under full control of the attacker, the latter cannot guess the secret data of the program in reasonable time. Implementation of a program according to this principle is commonly called “white box” implementation.

However, “white box” implementation may prove to be complex and not guarantee a sufficient level of security in specific applications.

Several solutions have been put forward to counter a cloning attack with an improved level of security.

A first solution, described in document US2016/0182472, consists of implementing a cryptographic program in part by a terminal and in part by a SIM card.

Actually, confiding execution of a part of the program in the SIM card has the output data of the program depend on the SIM card, therefore reinforcing the security of the cryptographic processing.

But the disadvantage of this solution is slowing down execution of the cryptographic program, where the SIM card in fact has limited hardware resources for executing part of the cryptographic program.

Another disadvantage of this solution is having to modify the internal operation of the SIM card, which is often not possible given that the configuration of a SIM card is generally under the exclusive control of the operator selling the SIM card.

Finally, such a solution is not effectively protected from replay attacks.

A second solution, described in document U.S. Pat. No. 9,264,899, consists of a cryptographic processing procedure implemented by means of a cryptographic program, the program being intended to be executed by a terminal, the terminal being further capable of communicating with a SIM card, the method comprising the following steps implemented by the terminal:
sending, to the SIM card, an execution command of internal processing by the secure element,
receiving a response datum specific to the SIM card produced by the internal processing executed by the SIM card,
verifying the response datum, and execution r non-execution of the program as a function of the result of the verification.

According to this solution, the terminal makes the decision to execute the program as a function of the SIM card, or not.

But a disadvantage of this second solution is that it requires sharing of a cryptographic datum between the SIM card and the mobile terminal, which is complex to implement.

### EXPLANATION OF THE INVENTION

An aim of the invention is to overcome the cited disadvantages of the prior art.

According to a first aspect of the invention, a method for configuring a cryptographic program intended to be executed by a terminal is therefore proposed, the method comprising the following steps implemented by the terminal:
sending to a secure element at least one execution command of an internal processing to be executed by the secure element,
receiving at least one response datum produced by the internal processing executed by the secure element, the response datum being specific to the secure element,
updating the cryptographic program according to the received response datum, such that output data produced by the cryptographic program before and after the updating are different.

According to the proposed method, the secure element is not used directly to execute the cryptographic program itself. The response datum it supplies serves as parameter for updating of the cryptographic program. As the response datum is specific to the secure element and unpredictable from the exterior, the output data of the cryptographic program depend finally on the secure element, reinforcing the security of the cryptographic program.

Moreover, a terminal has hardware resources far superior to those of a secure element. Also, the cryptographic program is executed by the terminal much faster than if it were in part executed by the secure element.

Furthermore, as the output data provided by the cryptographic program change once its updating is done, replay attacks are made much more difficult.

The method according to the first aspect of the invention may be completed by means of the following characteristics, taken individually or in combination when this is technically possible.

The updating of the cryptographic program may comprise modification of a correspondence table intended to be used by the cryptographic program.

The correspondence table may be intended to be used several times by the cryptographic program to produce the output data.

The method may further comprise steps of:
sending to the secure element a set of first input data of different values for the internal processing,
receiving a set of response data specific to the secure element, each response datum being produced by execution of the internal processing taking as input one of the first input data,
generating the correspondence table modified from the response data, such that use by the cryptographic program of the correspondence table is representative of processing comprising the internal processing.

The terminal may also send to the secure element a second input datum whereof the value is used during each of the executions of the internal processing.

The method may further comprise a step of exclusive disjunction of at least one first portion of each response datum and of a third input datum f constant value, so as to produce a set of output data, the modified correspondence table mapping all of the input data and all of the output data.

It may be provided that the input data are generated by a server and received by the terminal, and each output datum may be transmitted by the terminal to the server.

The internal processing may also use a secret key specific to the secure element, and the server may be in possession of the secret key.

The updating of the cryptographic program may further comprise modification of at least one external encoding function intended to be used by the cryptographic program.

The response datum may comprise a first portion and a second portion, and wherein updating of the cryptographic program comprises modification, on the basis of the first portion, of a correspondence table intended to be used by the cryptographic program, and modification, on the basis of the second portion, of at least one external encoding function intended to be used also by the cryptographic program.

The cryptographic program may be updated for each execution of the cryptographic program by the terminal, or else each time the cryptographic program has been executed a predetermined number of times by the terminal.

The secure element may be a membership card to a cellular network, for example a SIM card.

According to a second aspect of the invention, a method for authenticating a user on a terminal is also proposed, the method comprising the following steps of:
acquiring proof data by the terminal, for example graphic data acquired by at least one biometric sensor,
executing by the terminal a cryptographic program taking as input the acquired proof data, so as to produce data of encrypted output data,
sending the encrypted output data to a server configured to verify if the proof data correspond to predetermined reference data,
updating of the cryptographic program by means of the method according to the first aspect of the invention.

According to a third aspect of the invention, a computer program product is also proposed comprising program code instructions for conducting the steps of the method according to the first aspect of the invention for configuring a cryptographic program, when this method is executed by at least one processor, or even conducting the steps of the authentication method according to the second aspect.

According to a fourth aspect of the invention, a terminal is further proposed comprising:
a cryptographic program configured to produce at least one output datum, when the cryptographic program is executed by the terminal,
a communication interface with a secure element configured to execute internal processing, the communication interface being configured for:
   sending to the secure element at least one execution command of the internal processing by the secure element,
   receiving at least one response datum produced by the internal processing executed by the secure element, the response datum being specific to the secure element,
at least one processor configured to update the cryptographic program according to the received response datum, such that the output data produced by the cryptographic program before and after the updating are different.

### DESCRIPTION OF THE FIGURES

Other characteristics, aims and advantages of the invention will emerge from the following description which is purely illustrative and non-limiting, and which must be considered in conjunction with the appended drawings, in which:

FIG. 1 schematically illustrates a terminal according to an embodiment of the invention.

FIG. 2 shows an authentication system according to an embodiment of the invention.

FIG. 3 shows an internal processing implemented by a secure element in the form of a block diagram, according to an embodiment.

FIG. 4 shows the steps of a method for updating a cryptographic program, according to an embodiment of the invention.

FIG. 5 shows the steps of an authentication method using a cryptographic program, according to an embodiment of the invention.

In all figures, similar elements bear identical reference numerals.

### DETAILED DESCRIPTION OF THE INVENTION

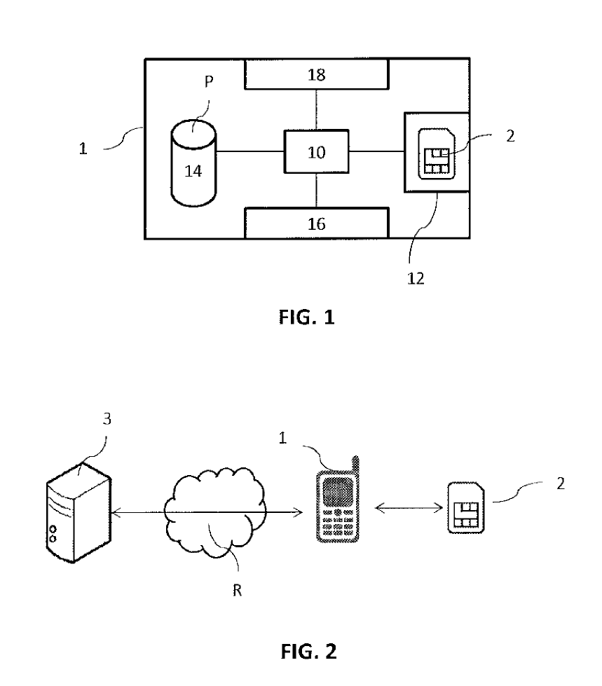

In reference to FIG. 1, a terminal 1 comprises at least one processor 10 and a communication interface 12 with a secure element 2.

The secure element 2 is a detachable electronic component such as a membership card to a cellular network (SIM card).

The communication interface 12 comprises a housing for receiving the secure element 2, and at least one connector for setting up a data communication channel between the processor 10 and the secure element 2, when the secure element is received in the housing.

The secure element 2 comprises a microprocessor, processor or circuit configured to execute internal processing F on the basis of data provided by the terminal 1 via the communication interface 12 and returning data to the terminal 1 via the communication interface 12. The internal processing F uses at least one secret datum specific to the secure element 2, this secret datum being unknown to the terminal 1.

The terminal 1 also comprises a memory 14 which stores a cryptographic program P, and a program for updating the cryptographic program P.

The processor 10 of the terminal 1 is adapted to execute the cryptographic program P and the updating program. The cryptographic program P and the updating program are however not executed by the secure element 2.

The terminal 1 further comprises an acquisition interface 16 of proof data, such as a biometric sensor.

The terminal 1 is for example a mobile terminal: smartphone, telephone, portable computer, etc.

The terminal 1 also comprises a communication interface 18 with a remote server 3, shown in FIG. 2. The communication interface 18 with the remote server 3 is for example adapted to connect to a cellular network R supported by the secure element 2.

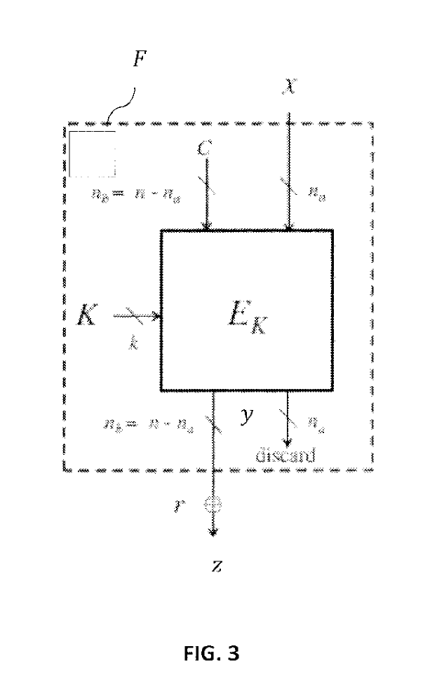

FIG. 3 illustrates an embodiment of internal processing F executable by the secure element 2.

The processing F takes as input: a first input datum x and a second input datum c.

The first input datum x is coded n a predetermined number of bits equal to nₐ.

The second input datum c is coded on a predetermined number of bits equal to n_{b}.

There is n=nₐ+n_{b}.

The internal processing F also uses a secret key K specific to the secure element 2, and stored by the latter. This key K is not known to the terminal 1. However, the values of the input data x and c, r are provided by the terminal 1.

The internal processing F comprises application of a function E_{K} which computes a response datum y on the basis of the data x, c and K.

The response datum y is coded on n=nₐ+n_{b} bits. This response datum y is constituted by a first portion coded on n_{b} bits, known as useful portion, and a second “discard” portion coded on nₐ bits.

For example, the function E_{K} is a block encryption function of AES type or the algorithm A3A8 known to the skilled person.

Preferably, nₐ<n_{b} is selected. This reduces the number of possible input values x which may be processed by the processing F and at the same time reduces the number of possible values for the datum z, assuming that the value of the parameters c and r is fixed.

The cryptographic program P is an encryption program implementing n encryption rounds, each encryption round comprising implementing a function Fₙ_{ₐ}^{r} using a predetermined correspondence table T(c, r, K).

The correspondence table T(c, r, K) is representative of a processing intended to generate an output datum z from the first input datum x, this processing comprising:
the internal processing F using the key K, the first input datum x and the second input datum c,
followed by exclusive disjunction applied to the response datum y provided by the internal processing F and to another datum r.

In other words, the correspondence table T(c, r, K) maps a set of possible values for the input datum x and a set of possible values for the output datum z.

When the cryptographic program P uses the correspondence table T(c, r, K), on the basis of a datum x having a given value, the cryptographic program P may determine the value of datum z which would be computed on the basis of a response datum y provided by the secure element 2 by application of the internal processing F to said value of the datum x, by using the parameters c and r.

The table T(c, r, K) is pre-computed and stored in the memory 14 of the terminal 1, therefore the cryptographic program P has no need to directly know the key K specific to the secure element 2 to carry out processing equivalent to the internal processing F.

During execution of the cryptographic program P, the same table T(c, r, K) is used during each of the n encryption rounds.

For example, the encryption rounds are implemented as described in part 5.1 of the document “White-box Cryptography Revisited: Space-Hard Ciphers” mentioned above.

This embodiment constitutes a “white box” implementation in terms of where it may be implemented in an environment constituting a white box without an attacker being able to recover secret data manipulated by the cryptographic program P (for example the key K implicitly used via the correspondence table T(c, r, K)).

Other embodiments however may be used by the cryptographic program P, for example the one described in document “Efficient and provable White-Box Primitives”, by Pierre-Alain Fouque et al. or in the document “Towards Practical Whitebox cryptography: Optimizing Efficiency and Space Hardness” by Andrey Bogdanov et al.

The cryptographic program P may further comprise at least one external encoding function using an external encoding table.

The cryptographic program P comprises for example an external encoding input function using an input table and/or an external encoding output function using an output table, each of these tables being stored in the memory 14. It is assumed from here that each encoding function is parameterizable.

### Method for Configuring the Cryptographic Program

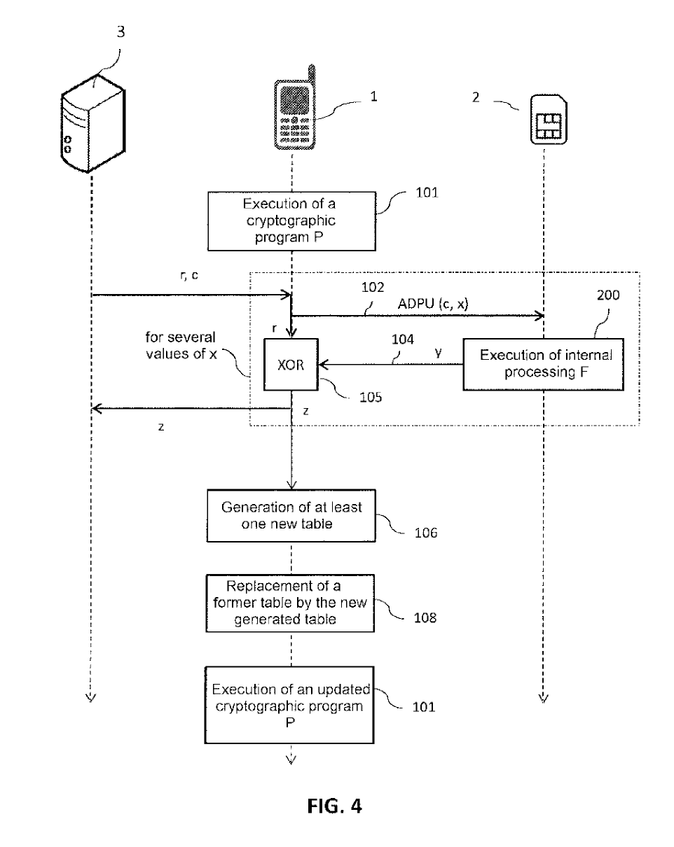

In reference to FIG. 4, the following steps are implemented by the terminal 1 to dynamically configure the cryptographic program P.

It is assumed that the table T(c₁, r₁, K) is stored in the memory 14 of the terminal 1, i.e., a table pre computed on the basis of the values c₁ and r₀ for the parameters r and c.

New values are generated for the parameters r and c, new values referred as r₁ and c₁. These values are generated for example by the server 3 and transmitted to the terminal 1.

The processor 10 of the terminal 1 controls sending of an execution command of the internal processing F to the secure element 2, typically via a command in ADPU format (step 102).

Also, the processor 10 controls sending the new value c_{z} to the secure element 2, such that this value is used as input datum c by the internal processing F.

The value r₁ is further stored in the memory 14 of the terminal 1.

The processor 10 of the terminal 1 also determines a first value for the input datum x. Because the datum x is coded on nₐ bits, this first value is selected in a set of 2ⁿ^{ₐ} possible values for this datum x. For example, if nₐ=8, the datum x may only take 256 different values (for example from 0 to 255).

The processor 10 controls sending to the secure element 2 of this value selected for the datum x during step 102.

The different input data x, c transmitted to the secure element may be transmitted in separate messages or the same message.

In response to receipt of the command and these data, the secure element 2 implements the internal processing F by using as input data the value c₁ for the datum C and the value x sent by the terminal 1, and on their basis produces a response datum y having a certain value (step 200).

The value of the response datum y depends on the value c₁ for the parameters c provided by the terminal 1, and also depends on the first value of the datum x also provided by the terminal 1.

The value of this response datum y produced by the secure element 2 further depends on the secret key K specific to the secure element 2. The response datum y is therefore specific to the secure element 2. In other words, the same internal processing F executed by several different secure elements on the basis of the same value of datum x and the same parameter values c, r produce response data y of different values, since these secure elements use secret keys K of different values.

The value of the response datum y is returned to the terminal 1 via the communication interface 12 (step 104).

The terminal 1 computes the exclusive disjunction (“XOR” operator) of the useful portion of the datum y coded on n_{b} bits and of the parameter r previously supplied to the element so as to produce a first output datum z (step 105). This computation improves the security of the method.

The operation of exclusive disjunction 105 may be replaced by an addition modulo of the length of the operands (this operation forms a group).

The processor 10 selects a second value for the datum x from the possible 2ⁿ^{ₐ} values.

The processor 10 controls a second execution 200 via the secure element 2 of the internal function F on the basis of this second value, but by reusing the same value c₁.

This second execution 200 returns a second value for the response datum y, second value which is transmitted 104 to the terminal 1.

Again, the terminal 1 computes the exclusive disjunction of the useful portion of the datum y coded on n_{b} newly received bits and of the value r₁, so as to produce a new output datum z (step 105).

The step 200 is repeated 2ⁿ^{ₐ} times by command of the terminal 1, as well as step 105. Each time, a different value for the datum x is passed as input of the internal processing F. The values c₁, r₁ for the parameters c and r are however the same for each execution of the internal processing F and of the exclusive disjunction. A set of 2ⁿ^{ₐ} response data y of different values and corresponding respectively to the 2ⁿ^{ₐ} possible values for the input datum x is thus returned to the terminal 1, and a set of 2ⁿ^{ₐ} output data z of different values and corresponding respectively to the 2ⁿ^{ₐ} possible values for the input datum x is generated as a consequence.

It may be provided for example for a command to be transmitted via the terminal 1 to the secure element 2 with all necessary input data so that the 2ⁿ^{ₐ} calls to the internal processing F are implemented simultaneously.

The processor 10 then updates the cryptographic program P on the basis of the output data z generated by the terminal.

The updating is such that output data produced by the cryptographic program P, during its execution by the processor 10, are different before and after the updating.

The updating comprises the following sub-steps in an embodiment.

On the basis of 2ⁿ^{ₐ} output data z, the processor 10 generates a new correspondence table T(c₁, r₁, K) intended to be used by the cryptographic program P, when the cryptographic program P is executed by the processor 10 (step 106).

This new table T(c₁, r₁, K) maps two sets: all of the nₐ values f datum x passed to internal processing F, and all f the nₐ output data z dependent on the response data y returned by the internal processing F. In this way, use by the cryptographic program P of the new correspondence table is representative of the processing comprising the internal processing F followed by exclusive disjunction, on the basis of the parameter values c₁, r₁ and K.

The processor replaces the correspondence table T(c₀, r₀, K) to date used by the cryptographic program P by the new table T(c₁, r₁, K) which has just been generated (step 108). This replacement may typically be implemented by overwriting in the memory 14 of the values of the former table by the values f the new table generated.

Consequently, the table T(c₁, r₁, K), and the latter will be used in place of the table T(c₀, r₀, K) during later execution in the cryptographic program P (step 101).

It is not obligatory to simultaneously change the values of both parameters c and r to update the cryptographic program P, in keeping with the preceding example. It is in fact possible to modify the value of a single one of these parameters, and generate a new table on the basis of this sole modification, for example generate the table T(c₀, r₁, K) or the table T(c₁,r₀, K).

As pointed out previously, the cryptographic program P is executed by the processor 10 of the terminal 1, but not by the secure element 2 itself. The secure element 2 serves only to generate cryptographic hardware which may be used later by the terminal 1 alone. This is advantageous for several reasons.

First, the secure element 2 is used very simply by leveraging its internal processing F: the terminal 1 controls only the inputs and outputs of this internal processing. The number of calls nₐ to the internal processing F is relatively low, especially when nₐ<n_{b} is selected (256 calls in the event where nₐ=8). This minimum use of the secure element 2 is therefore much simpler to implement than a cryptographic program P comprising a part executed by a terminal and a part executed by a secure element, as is proposed in document US2016/0182472.

Second, the secure element 2 has hardware resources generally much more limited than those of the terminal 1 (the processor 10 being especially much faster than the microprocessor 10 executing the internal processing in the secure element 2). The cryptographic program P is executed by the terminal 1 much faster than the cryptographic program P described in document US2016/0182472.

Third, the cryptographic hardware generated on the basis of the response data provided by the secure element 2 may very welt be used several times by the terminal 1. This is the case for example of the embodiment previously described: the updated correspondence table is used during each encryption round of the cryptographic program P, and may even be used for several executions of the cryptographic program P.

The updating of the cryptographic program P may be implemented each time the cryptographic program P has been executed a predetermined number of times by the terminal 1, for example every 10 executions of the cryptographic program P.

In particular, the updating of the cryptographic program P may be implemented for each execution of the cryptographic program P (before or after said execution). This gives a very high level of security to a method using the cryptographic program P.

The updating method according to the embodiment presented to date has modified the values of a correspondence table used by the cryptographic program P.

At least one new external encoding table intended to be used by the cryptographic program P may further be generated during updating of the cryptographic program P. Therefore, updating of the cryptographic program P modifies the external encoding table used by the cryptographic program P during its execution by the terminal 1.

Advantageously, the new external encoding table is determined according to at least one of the “discard” data produced earlier by the internal processing F but not used to generate the output data z. This heightens the differences in behavior of the cryptographic program P before and after updating without as such requesting the secure element 2 more.

An external input encoding function of the cryptographic program P, i.e., an external encoding function applied to input data provided to the cryptographic program P is updated, for example.

Alternatively, or in addition, an external output encoding function of the cryptographic program P is updated, i.e., an external encoding function which produces the output data of the cryptographic program P.

### Example of Application: Authentication Method

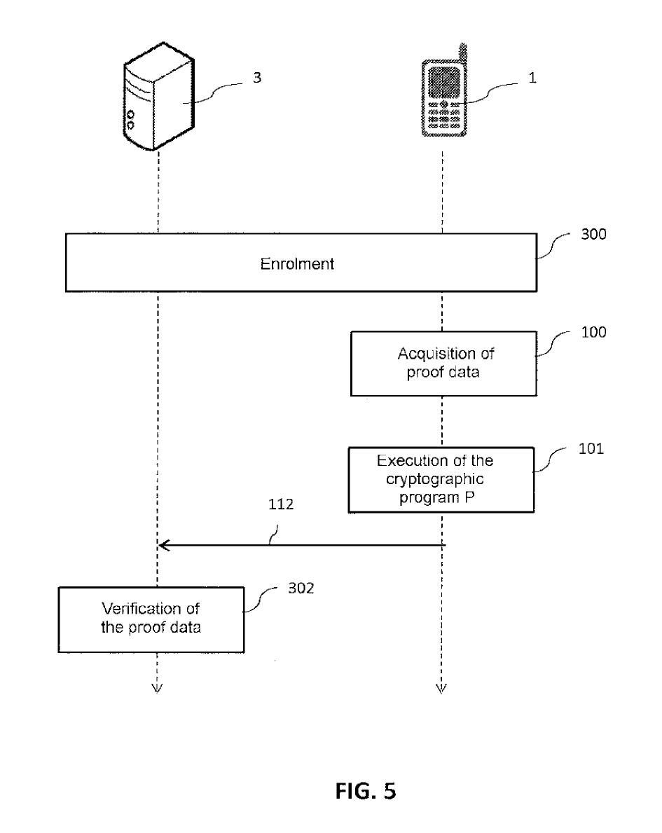

In reference to FIG. 5, an authentication method using the cryptographic program P comprises the following steps.

During a previous enrolment step 300, secret reference data specific to a user of the terminal 1 are stored by the server 3.

Later, a user wants to be authenticated with the terminal 1 for example for the purpose of accessing a secure service of the terminal 1 or of the server 3.

For this, the acquisition interface 16 acquires proof data of the same type as the secret reference data acquired during the previous enrolment (step 100).

For example, the proof data are graphic data, or even video data, acquired by a biometric sensor of the terminal 1. The graphic data are representative of part of the body of the user of the terminal 1 (iris, fingerprint, etc.).

The proof data are encrypted by the cryptographic program P (step 101).

The cryptographic program P thus generates output data (encrypted) from the acquired proof data, by using especially the correspondence table T(c, r, K) located in the memory 14.

The encrypted output data are transmitted to the server 3 (step 112).

The server 3 proceeds with verification of the proof data (step 302). This verification comprises for example comparison between the encrypted data received by the server with secret reference data associated with the terminal 1 and/or the secure element 2. As a function of the result of verification, the user of the terminal 1 will be authorized or not to access the requested service.

The cryptographic program P used during this authentication method may be updated via the updating method described previously. If the cryptographic program P is requested after or before its updating described previously, the encryption of proof data uses the correspondence table T(c₀, r₀, K). If the cryptographic program P is requested after or before its updating described previously, the encryption of the proof data uses the correspondence table T(c₁, r₁, K). In both cases, the output data of the cryptographic program P (i.e., the encrypted data transmitted to the server 3) will have different values.

Preferably, the parameter values c, r provided by the terminal 1 to the secure element 2 for the purpose of producing the response data are originally selected by the server 3, then transmitted to the terminal 1, for example via a messaging service (SMS). Such generation may be required by the terminal 1 in a request message sent by the terminal 1 to the server 3.

The method for configuring the cryptographic program is not limited to the embodiments described previously; it may in fact form the object of other variants.

It is possible for example to store several candidate tables in the memory 14 f the terminal, and select one of them as a function of a response datum z provided by the secure element in light of its use by the cryptographic program.

1. A method for configuring a cryptographic program (P) intended to be executed by a terminal, the method comprising the following steps implemented by the terminal:
sending to a secure element at least one execution command of an internal processing (F) to be executed by the secure element,
receiving at least one response datum (y) produced by the internal processing (F) executed by the secure element, the response datum (y) being specific to the secure element,
updating the cryptographic program (P) according to the received response datum (y), such that output data produced by the cryptographic program (P) before and after the updating are different,
wherein the response datum (y) comprises a first portion and a second portion, and wherein the updating of the cryptographic program (P) comprises modification, on the basis of the first portion, of a correspondence table intended to be used by the cryptographic program (P), and modification, on the basis of the second portion, of at least one external encoding function intended to be used also by the cryptographic program (P).

2. The method according to claim 1 wherein the updating of the cryptographic program (P) comprises modification of the correspondence table intended to be used by the cryptographic program (P).

3. The method according to claim 2, wherein the correspondence table is intended to be used several times by the cryptographic program (P) to produce the output data.

4. The method according to claim 2, comprising steps of:
sending to the secure element a set of first input data (x) of different values for the internal processing (F),
receiving a set of response data (y) specific to the secure element, each response datum (y) being produced by execution of the internal processing (F) taking as input one of the first input data (x),
generating the correspondence table modified from the response data (y), such that use by the cryptographic program (P) of the correspondence table is representative of processing comprising the internal processing (F).

5. The method according claim 4, wherein the terminal (1) also sends to the secure element a second input datum (c) whereof the value is used during each of the executions of the internal processing (F).

6. The method according to claim 4, further comprising a step of exclusive disjunction of at least one first portion of each response datum (y) and of a third input datum (r) of constant value, so as to produce a set of output data (z), the modified correspondence table mapping all of the input data (x) and all of the output data (z).

7. The method according to claim 4, wherein
the input data (x, c, r) are generated by a server and received by the terminal,
each output datum (z) is transmitted by the terminal to the server.

8. The method according to claim 7, wherein the internal processing (F) also uses a secret key (K) specific to the secure element, and wherein the server is in possession of the secret key (K).

9. The method according to claim 1, wherein the updating of the cryptographic program (P) comprises modification of the at least one external encoding function intended to be used by the cryptographic program (P).

10. The method according to claim 1, wherein the cryptographic program (P) is updated for each execution of the cryptographic program (P) by the terminal, or else each time the cryptographic program (P) has been executed a predetermined number of times by the terminal.

11. The method according to claim 1, wherein the secure element is a subscriber card to a cellular network, for example a SIM card.

12. A method for authenticating a user on a terminal, the method comprising the following steps of:
acquiring proof data by the terminal, for example graphic data acquired by at least one biometric sensor,
executing by the terminal a cryptographic program (P) taking as input the acquired proof data, so as to produce data of encrypted output data,
sending the encrypted output data to a server configured to verify if the proof data correspond to predetermined reference data,
updating the cryptographic program (P) by means of the method according to claim 1.

13. A computer program product comprising program code instructions for executing the steps of the method according to claim 1 for configuring a cryptographic program (P), when this method is executed by at least one processor.

14. A terminal comprising:
a cryptographic program (P) configured to produce at least one output datum, when the cryptographic program (P) is executed by the terminal,
a communication interface with a secure element configured to execute internal processing (F), the communication interface being configured for:
sending to the secure element at least one execution command of the internal processing (F) by the secure element,
receiving at least one response datum (y) produced by the internal processing (F) executed by the secure element, the response datum (y) being specific to the secure element,
at least one processor configured to update the cryptographic program (P) according to the received response datum (y), such that the output data produced by the cryptographic program (P) before and after the updating are different,
wherein the response datum (y) comprises a first portion and a second portion, and wherein the updating of the cryptographic program (P) comprises modification, on the basis of the first portion, of a correspondence table intended to be used by the cryptographic program (P), and modification, on the basis of the second portion, of at least one external encoding function intended to be used also by the cryptographic program (P).
